(19) United States
(12) Patent Application Publication
(10) Pub. No.: US 2008/0222322 A1
(43) Pub. Date: Sep. 11, 2008

(54) Structure for an Apparatus Configured to Implement Commands in Input/Output (IO) Hub

(75) Inventor: Paul Gregory Curtis, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, Armonk, NY (US)

(21) Appl. No.: 12/124,433

(22) Filed: May 21, 2008

Related U.S. Application Data
(63) Continuation-in-part of application No. 11/548,420, filed on Oct. 11, 2006.

(51) Int. Cl. G06F 3/00

(52) U.S. Cl. 710/51

(57) ABSTRACT

A design structure comprising a schematic structure of an apparatus configured to implement commands in an input/output (IO) hub comprising a programmable command generator having an input coupled to an external interface and an output providing commands. The programmable command generator selectively couples commands in a path between a front end of the IO hub and an IO hub logic address and command routing output.

### CROSS-REFERENCE TO RELATED APPLICATION

This application is a continuation-in-part of co-pending U.S. patent application Ser. No. 11/548,420, filed Oct. 11, 2006, which is herein incorporated by reference.

### FIELD OF THE INVENTION

The present invention relates generally to a design structure, and more specifically to a design structure for implementing commands with a programmable command generator provided within an input/output (IO) hub.

### DESCRIPTION OF THE RELATED ART

IO hubs and bridges often are required to route multiple different command types, such as memory mapped addresses, interrupts, coherency, and the like, from a processor bus to multiple different locations. Memory mapped addresses may pass through several address decodes in the IO hub and bridge before reaching their final destination.

When addressing or routing issues inevitably arise beneath the IO hub in a lab environment, it can be very difficult to recreate the problem. This results because the IO hub is a slave to all operations directed by the processor. Therefore there may be a lot of overhead required to generate the command sequence causing the fail. This typically means that software needs updates to trap on the error, if an ideal trap is even possible.

A need exists for a mechanism for more effectively and efficiently performing IO operations.

### SUMMARY OF THE INVENTION

An embodiment of the present invention is to provide design structure for an apparatus configured to implement commands in an input/output (IO) hub.

In another embodiment of the present invention a design structure is provided for an apparatus configured to implement commands in an input/output (IO) hub. The IO hub includes a programmable command generator having an input coupled to an external interface and an output providing commands. The programmable command generator selectively couples commands in a path between a front end of the IO hub and an IO hub logic address and command routing output.

In accordance with another embodiment of the invention, a multiplexer is provided in the path between the front end of the IO hub and the IO hub logic address and command routing output and has an input connected to the output of the programmable command generator. A multiplexer select is applied to the multiplexer to select between normal operation of the IO hub and commands from the programmable command generator.

In accordance with another embodiment of the invention, the programmable command generator provides at least one predefined command type that is address programmable. The predefined command type includes a command type supported by a processor bus connected to the front end of the IO hub. The programmable command generator enables identifying bad machine path verification. The programmable command generator enables injecting errors on a single, directly controllable command, or data, allowing much more robust bad machine path verification in a lab environment.

In accordance with another embodiment of the invention, the programmable command generator enables independent control of the IO hub, without requiring software or processor communication overhead. The programmable command generator provides commands enabling initial bring up of devices coupled to the output of the IO hub. The programmable command generator provides the type of control needed to debug or easily recreate typical initial bring up problems.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating an input/output (IO) hub with a programmable command generator in accordance with the preferred embodiment.

FIG. 2 is a flow diagram of a design process.

### DETAILED DESCRIPTION OF THE PREFERRED EMBODIMENTS

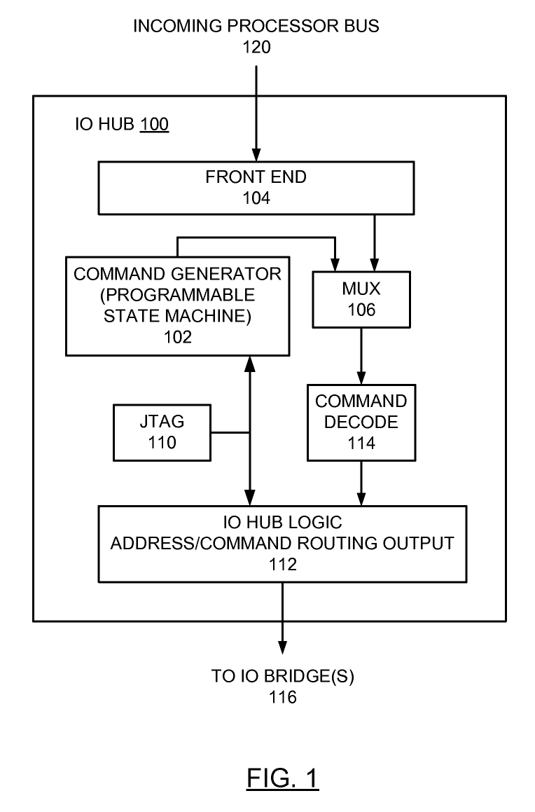

Having reference now to the drawings, in FIG. 1, there is shown an input/output (IO) hub generally designated by the reference character 100 in accordance with the preferred embodiment. IO hub 100 includes a programmable command generator 102 in accordance with the preferred embodiment.

A front end 104 of the IO hub 100 is connected to an input of a two-input multiplexer (MUX) 106. The programmable command generator 102 is connected to another input of a two-input multiplexer (MUX) 106. A multiplexer select input MUX SELECT 108 is applied to the multiplexer 106 to select between normal operation of the IO hub 100 and commands from the programmable command generator 102.

The programmable command generator 102 has an input coupled to an external interface, such as JTAG function 110, as shown. Alternatively an I2C external interface can be connected to the input of the programmable command generator 102. The JTAG function 110 is connected between the programmable command generator 102 and an IO hub logic address and command routing output 112.

An output of the programmable command generator 102 provides commands applied to MUX 106. A command decode 114 is connected to the output of MUX 106 and to the IO hub logic address and command routing output 112. The IO hub logic address and command routing output 112 of the IO hub is connected to one or more IO bridges 116. An incoming processor bus 120 is connected to the front end of the IO hub 104.

The programmable command generator 102 selectively couples commands in a path between the front end of the IO hub 104 and the IO hub logic address and command routing output 112. The programmable command generator 102 enables independent control of the IO hub 100.

A state machine and registers, which present command packets in the same format, as delivered from the front end logic 104 implement the command generator 102. Registers contained in command generator 102 are provided for command and address/data selection, as well as error injections. The programmable command generator 102 provides a register bit to select between normal operation and artificial command generation that is applied to the input MUX SELECT 108.

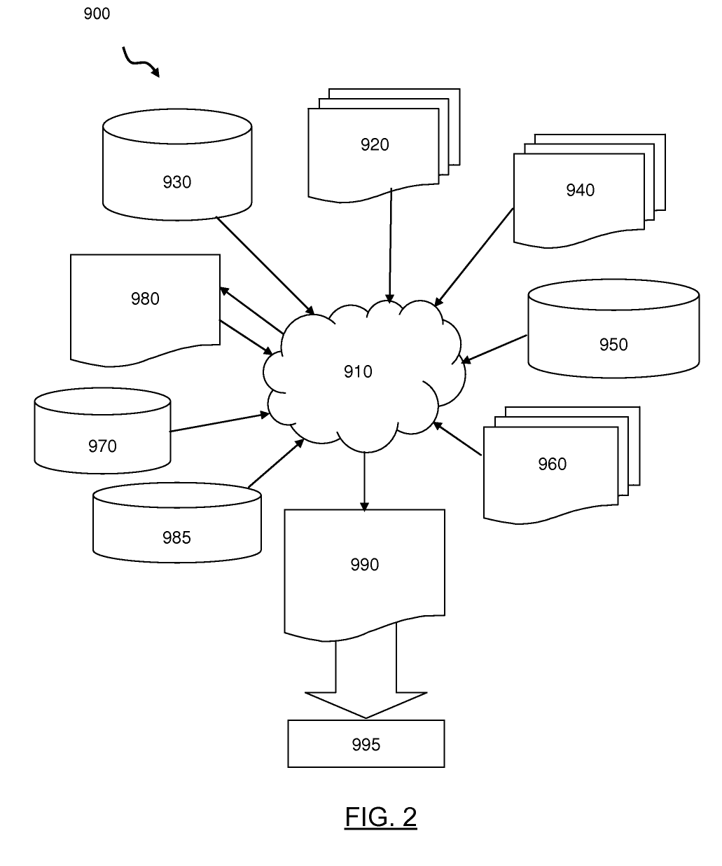

FIG. 2 shows a block diagram of an exemplary design flow 900 used for example, in semiconductor design, manufacturing, and/or test. Design flow 900 may vary depending on the type of IC, circuit, apparatus, etc. being designed. For example, a design flow 900 for building an application specific IC (ASIC) may differ from a design flow 900 for designing a standard component. Design structure 920 is preferably an input to a design process 910 and may come from an IP provider, a core developer, or other design company or may be generated by the operator of the design flow, or from other sources. Design structure 920 comprises an embodiment of the invention as shown in FIG. 1 in the form of schematics or HDL, a hardware-description language (e.g., Verilog, VHDL, C, etc.). In other words, design structure 920 contains a schematic representation of the embodiment shown in FIG. 1. Design structure 920 may be contained on one or more machine readable medium. For example, design structure 920 may be a text file or a graphical representation of an embodiment of the invention as shown in FIG. 1. Design process 910 preferably synthesizes (or translates) an embodiment of the invention as shown in FIG. 1 into a netlist 980, where netlist 980 is, for example, a list of wires, transistors, logic gates, control circuits, I/O, models, etc. that describes the connections to other elements and circuits in an integrated circuit design and recorded on at least one of machine readable medium. For example, the medium may be a CD, a compact flash, other flash memory, a packet of data to be sent via the Internet, or other networking suitable means. The synthesis may be an iterative process in which netlist 980 is resynthesized one or more times depending on design specifications and parameters for the circuit.

Design process 910 may include using a variety of inputs; for example, inputs from library elements 930 which may house a set of commonly used elements, circuits, and devices, including models, layouts, and symbolic representations, for a given manufacturing technology (e.g., different technology nodes, 32 nm, 45 nm, 90 nm, etc.), design specifications 940, characterization data 950, verification data 960, design rules 970, and test data files 985 (which may include test patterns and other testing information). Design process 910 may further include, for example, standard circuit design processes such as timing analysis, verification, design rule checking, place and route operations, etc. One of ordinary skill in the art of integrated circuit design can appreciate the extent of possible electronic design automation tools and applications used in design process 910 without deviating from the scope and spirit of the invention. The design structure of the invention is not limited to any specific design flow. Design process 910 preferably translates an embodiment of the invention as shown in FIG. 1, into a second design structure 990. Design structure 990 resides on a storage medium in a data format used for the exchange of layout data of integrated circuits and/or symbolic data format (e.g., information stored in a GDSII (GDS2), GL1, OASIS, map files, or any other suitable format for storing such design structures). Design structure 990 may comprise information such as, for example, symbolic data, map files, test data files, design content files, manufacturing data, layout parameters, wires, levels of metal, vias, shapes, data for routing through the manufacturing line, and any other data required by a semiconductor manufacturer to produce an embodiment of the invention as shown in [fill in figure or figures that represent the design]. Design structure 990 may then proceed to a stage 995 where, for example, design structure 990: proceeds to tape-out, is released to manufacturing, is released to a mask house, is sent to another design house, is sent back to the customer, etc.

While the present invention has been described with reference to the details of the embodiments of the invention shown in the drawing, these details are not intended to limit the scope of the invention as claimed in the appended claims.

What is claimed is:

1. A design structure embodied in a machine readable medium, the design structure comprising:
a schematic representation of an apparatus configured to implement commands in an input/output (IO) hub the IO hub comprising a front end of the IO hub, a IO hub logic address, and a command routing output,
and wherein the schematic representation of the apparatus further comprises a programmable command generator having an input coupled to an external interface and an output providing commands, wherein the programmable command generator is configured to selectively couple commands in a path between the front end of the IO hub and the IO hub logic address and the command routing output.

2. The design structure of claim 1, wherein the design structure comprises a netlist.

3. The design structure of claim 1, wherein the design structure resides on storage medium as a data format used for the exchange of layout data of integrated circuits.

4. The design structure of claim 2 wherein the schematic representation of the apparatus comprises a multiplexer provided in the path between the front end of the IO hub and the IO hub logic address and command routing output; the multiplexer having an input connected to the output of the programmable command generator.

5. The design structure of claim 4 wherein the schematic representation of the apparatus further comprises a multiplexer select input applied to the multiplexer to select between normal operation of the IO hub and commands from the programmable command generator.

6. The design structure of claim 5 wherein the programmable command generator provides at least one predefined command type that is address programmable.

7. The design structure of claim 6 wherein the predefined command type includes a command type supported by a processor bus connected to the front end of the IO hub.

8. The design structure of claim 7 wherein the programmable command generator enables identifying bad machine path verification.

9. The design structure of claim 8 wherein the programmable command generator further enables injecting errors on a single, directly controllable command.

10. The design structure of claim 9 wherein the programmable command generator further enables independent control of the IO hub, without requiring software or processor communication overhead.

11. The design structure of claim 10 wherein the programmable command generator is configured to provide commands enabling initial bring up of devices coupled to the output of the IO hub.

12. The design structure of claim 11 wherein the programmable command generator is further configured to provide control to debug initial bring up problems.

13. The design structure of claim 3 wherein the schematic representation of the apparatus comprises a multiplexer provided in the path between the front end of the IO hub and the IO hub logic address and command routing output; the multiplexer having an input connected to the output of the programmable command generator.

14. The design structure of claim 13 wherein the schematic representation of the apparatus further comprises a multiplexer select input applied to the multiplexer to select between normal operation of the IO hub and commands from the programmable command generator.

15. The design structure of claim 14 wherein the programmable command generator provides at least one predefined command type that is address programmable.

16. The design structure of claim 15 wherein the predefined command type includes a command type supported by a processor bus connected to the front end of the IO hub.

17. The design structure of claim 16 wherein the programmable command generator enables identifying bad machine path verification.

18. The design structure of claim 17 wherein the programmable command generator further enables injecting errors on a single, directly controllable command.

19. The design structure of claim 18 wherein the programmable command generator further enables independent control of the IO hub, without requiring software or processor communication overhead.

20. The design structure of claim 19 wherein the programmable command generator is configured to provide commands enabling initial bring up of devices coupled to the output of the IO hub, and to provide control to debug initial bring up problems.
